(19) United States
(12) Patent Application Publication
(10) Pub. No.: US 2023/0399025 A1
(43) Pub. Date: Dec. 14, 2023

(54) METHOD FOR ADJUSTING AN ADJUSTABLE PART, PROVIDED IN ADDITION TO A VEHICLE DOOR, AT A BODYWORK OPENING

(71) Applicants: Brose Fahrzeugteile SE & Co. Kommanditgesellschaft, Bamberg, Bamberg (DE); BODE - DIE TUER GMBH, Kassel (DE)

(72) Inventors: Markus ROSENTHAL, Bamberg (DE); Christian GITTER, Zeil am Main (DE)

(21) Appl. No.: 18/248,367

(22) PCT Filed: Sep. 2, 2021
(86) PCT No.: PCT/EP2021/074255

§ 371 Date: Apr. 7, 2023

(30) Foreign Application Priority Data
Oct. 9, 2020 (DE) 10 2020 212 786.7

(51) Int. Cl. B60W 60/00; E05F 15/40; E05F 15/73

(52) U.S. Cl. CPC B60W 60/0025; E05F 15/40; E05F 15/73; E05F 2015/767; E05Y 2400/852; E05Y 2900/531; B60W 2420/52; B60W 2420/42

(57) ABSTRACT

It is provided a method for adjusting an adjustable part that is provided at a bodywork opening of a vehicle to be closed by at least one vehicle door, wherein a power-operated adjustment of the adjustable part is controlled by using at least one sensor device via which a person in the surroundings of the bodywork opening can be detected and via which a power-operated adjustment of the adjustable part can be triggered in order to make it easier for a person to board or alight from a vehicle when the vehicle door is open.

### BACKGROUND

The disclosure relates to a method for adjusting an adjustable part that is provided at a bodywork opening of a vehicle, which is to be closed by at least one vehicle door.

The adjustable part for example can be a boarding aid with an extendable ramp, in order to make it easier for a person to board or alight from the vehicle when the vehicle door is open. Such adjustable parts are known for example on motor vehicles of local public transportation. In practice, such adjustable parts regularly are to be adjusted manually, typically by a driver of the motor vehicle. In an adjustable part to be adjusted in a power-operated way, the adjustment is effected by means of at least one drive motor, wherein the driver of the motor vehicle then typically triggers the adjustment in a targeted way, when this is regarded as necessary after stopping the motor vehicle, i.e. for example when a person of reduced mobility is identified.

What is known already are sensor devices via which a power-operated adjustment of a vehicle door is controlled. Via the sensor device, an object in the surroundings of the bodywork opening is detected in a contactless way, and a power-operated adjustment of the vehicle door is triggered when a particular operating event, such as a person approaching the vehicle and/or a particular user-side gesture, has been identified.

### SUMMARY

While an adjustment of an adjustable part, in order to make it easier for a person to board or alight from the vehicle, is easily possible in human-driven vehicles, difficulties might very well arise in the near future with autonomously driving vehicles. In such cases, even an only temporary obstacle that is placed in an adjustment path of a vehicle door can permanently block the adjustment of the vehicle door and impede the further travel of the vehicle. In any case, for lack of a driver in autonomously driving vehicles, the driver will not be able to intervene in order to remove the obstacle. In this respect, the proposed solution likewise can provide relief.

The proposed solution provides a method for adjusting an adjustable part that is provided at a bodywork opening of a vehicle to be closed by at least one vehicle door, wherein a power-operated adjustment of the adjustable part is controlled by using at least one sensor device via which a person in the surroundings of the bodywork opening can be detected and via which a power-operated adjustment of the adjustable part can be triggered in order to make it easier for a person to board or alight from the vehicle when the vehicle door is open.

In accordance with the proposed solution it thus is provided to identify an object in the surroundings of a bodywork opening as a person and in response thereto adjust an adjustable part in a power-operated way for the facilitated entry and/or exit, in addition to a vehicle door. In this connection, the triggering of the adjustment of the adjustable part possibly can be linked to further criteria, for example whether the identified person is assessed as having reduced mobility, e.g. by sensorially detecting that the person is sitting in a wheelchair, brings along a wheelchair, or the person leans on a walking stick or a crutch. Such a detection by sensors is possible for example via a camera or a lidar sensor as part of a sensor device. In principle, it is not absolutely necessary in the proposed solution that the vehicle door is already open when an adjustment of the adjustable part is effected, although this is likewise possible. The adjustable part can also be adjusted already before or on opening of the vehicle door.

In one design variant, an object in the surroundings of the bodywork opening can be detected by using the at least one sensor device, and the detected object is assigned to one of at least two predefined object classes, e.g. by means of a correspondingly trained electronic evaluation logic. Then, for example via an assignment of the object to a first object class of the at least two predefined object classes, there is signaled a detection of a person for which an adjustment of the adjustable part is to be triggered, while via an assignment of the object to a second object class of the at least two predefined object classes there is signaled e.g. the detection of an obstacle that limits an adjustment of the at least one vehicle door, of a group of persons or an (autonomously driving or remote-controlled) mobile transportation unit, e.g. a cargo transportation robot. Thus, depending on the classification of the object one of at least two different types of object is assumed, which in response thereto lead to different measures with respect to the adjustment of the adjustable part and possibly also of the at least one vehicle door.

According to one variant of the proposed method it is furthermore provided that the adjustable part is adjusted for a power-operated removal of an obstacle in the surroundings of a bodywork opening at which boarding or alighting from the vehicle is to be facilitated via the adjustable part.

This variant of the proposed solution hence proceeds from the fundamental idea to also use the adjustable part, via which boarding or alighting from the vehicle is to be made easier for a person when the vehicle door is open, to remove a potential obstacle in an adjustment path of at least one vehicle door of the vehicle, when an obstacle limiting an adjustment of the at least one vehicle door is detected via the at least one sensor device in the surroundings of the bodywork opening. Via the adjustable part to be adjusted in a power-operated way, an obstacle can be shifted out of the adjustment path of the vehicle door so that the vehicle door can again be opened or closed in a power-operated way. Alternatively or additionally, after removal of the obstacle an adjustment of the adjustable part into an adjustment position can be possible, which is provided for easier entry into or facilitated exit from the vehicle.

In one design variant, the at least one sensor device can be used to distinguish an object of a first object class from an object of at least one further object class, so that in dependence on the object class to which a detected object is assigned, one of at least two different adjustment scenarios is triggered for the power-operated adjustment of the adjustable part. The adjustment scenarios here can differ e.g. with respect to the course of an adjustment speed of the adjustable part, the course of an acceleration of the adjustable part and/or a course of the (extended) adjustable part itself, in particular with respect to a length of an adjustment path of the adjustable part or its inclination.

In one design variant, the at least one sensor device can be used for example to distinguish a person from an obstacle limiting an adjustment of the at least one vehicle door, so that in dependence on whether a person is detected in the surroundings of the bodywork opening or an obstacle limiting the adjustment of the at least one vehicle door, one of at least two different adjustment scenarios is triggered for the power-operated adjustment of the adjustable part. When a person is detected in the surroundings of the bodywork opening when the vehicle is stationary and the vehicle door is to be opened or closed, another adjustment scenario consequently is triggered than in the case of a detected obstacle, which must first be removed.

For example, when a person is detected in the surroundings of the bodywork opening, a first adjustment scenario is triggered, in which the at least one vehicle door and the adjustable part are adjusted in a power-operated way at the same time or one after the other (with respect to the beginning and the end of the respective adjusting movements) in a coordinated way. Consequently, in the first adjustment scenario the at least one vehicle door and the adjustable part are adjusted at the same time or one after the other, i.e. for example in a particular temporal sequence relative to each other. After completion of the respective adjusting movements of the vehicle door on the one hand and of the adjustable part on the other hand and then after the vehicle door is opened, the adjustable part with an open vehicle door then is in an adjustment position in which it is made easier for a person to board or alight from the vehicle. When an obstacle is detected in the surroundings of the bodywork opening, on the other hand, a second adjustment scenario is triggered, in which merely the adjustable part is adjusted in a power-operated way. The power-operated adjustment of the adjustable part then serves the removal of the obstacle. When the second adjustment scenario is completed and, after a (renewed) examination by means of the at least one sensor device, an obstacle limiting the adjustment of the vehicle door cannot be detected any more, the first adjustment scenario possibly can be triggered, so that the at least one vehicle door and the adjustable part are adjusted at the same time or one after the other in a coordinated way. In particular, it is not absolutely necessary that the adjustable part is again retracted into a starting position only after completion of an adjustment according to the second adjustment scenario, in order to subsequently be adjusted according to the first adjustment scenario.

In principle, an object of a first object class, such as e.g. a person, and an object of at least one second object class, such as e.g. an obstacle, a group of persons or a mobile transportation unit, can be distinguishable from each other via the at least one sensor device with reference to a size, a weight and/or a contour. In such a design variant, the at least one sensor device for example is adapted to distinguish a person and an obstacle in the surroundings of the bodywork opening from each other with reference to a size, a weight and/or a contour. Size and contour here can be distinguished from each other by means of measurement data that are generated by at least one suitable sensor element of the at least one sensor device. For example, this is possible by using a camera or a lidar sensor as part of the at least one sensor device. A weight can be derived from sensorially detected measurement data, without actually having to weigh the person or the obstacle. The distinction made possible by means of the at least one sensor device involves a kind of classification of an object detected in the surroundings of the bodywork opening, so that e.g. an object is then classified either as a person or as an obstacle.

In one design variant, a further distinction of a detected obstacle can be provided in addition, in order to for example distinguish between massive obstacles not to be removed by the adjustable part and shiftable, i.e. mobile obstacles, which can be shifted by the adjustable part. For example, non-removable stone barriers or barrier posts can be distinguished from shiftable bags, sacks or garbage.

A power-operated adjustment of the adjustable part when a person is detected in the surroundings of the bodywork opening can differ from a power-operated adjustment of the adjustable part when an obstacle is to be removed, for example as regards the course of an adjustment speed of the adjustable part, the course of an acceleration of the adjustable part and/or a course, in particular a length of an adjustment path of the adjustable part or its inclination. For example, the adjustable part can be extended at a greater speed and/or greater acceleration and/or over a greater length, in order to remove an obstacle, as compared to a case in which the adjustable part is adjusted in order to make it easier for a person to board or alight from the vehicle when the vehicle door is open. This in particular includes the fact that for example in the case of an adjustable part with a ramp-shaped boarding aid the ramp-shaped boarding aid carries out a swivel movement in a first adjustment scenario, in order to place a front edge of the ramp-shaped boarding aid onto a base during or at the end of an extending operation, e.g. in order to bridge an existing gap between an adjoining base and a lower edge of the bodywork opening or between an adjoining curb and the lower edge of the bodywork opening. In a second adjustment scenario for removing an obstacle in the surroundings of the bodywork opening, on the other hand, such a swivel movement for example can be left out and the ramp-shaped boarding aid can be extended merely linearly in order to push an obstacle away. Of course, however, the adjusting movement of the adjustable part can also be identical for both adjustment scenarios.

In one design variant, an adjustment of the adjustable part for removing an obstacle during standstill of the vehicle is dependent on whether the obstacle was present already before standstill of the vehicle and/or for what period the obstacle is detected via the at least one sensor device. For example, an adjustment of the adjustable part for removing an obstacle only can be triggered when the obstacle has appeared after standstill of the vehicle, i.e. it is an obstacle placed only recently and hence a temporary obstacle. Alternatively or additionally, the adjustment can only be triggered when the obstacle is detected for a period exceeding a threshold value in order to prevent false triggering of the adjustment of the adjustable part, when for example a passenger (who has already boarded or is boarding) merely has briefly placed his or her luggage in the surroundings of the bodywork opening. By means of an electronic evaluation circuit (possibly an electronic evaluation circuit of the at least one sensor device or an electronic evaluation circuit of an electronic unit coupled to the sensor device) it here can be checked automatically whether an adjustment of the adjustable part for removing an obstacle during standstill of the vehicle actually is to be effected and hence the criteria described above are fulfilled.

An adjustment of the adjustable part for removing an obstacle can be monitored electronically with reference to at least one measured value. In this way, the adjustment can be stopped again when the at least one measured value exceeds a stored threshold value or when the at least one measured value falls below a stored threshold value. The respective stop criterion here is dependent on the detected measurement quantity. For example, the at least one measured value can be indicative of a motor current of a drive motor via which the adjustable part is adjusted. A motor current exceeding a threshold value for example indicates that the performance of a drive gear is not sufficient for the adjustable part in order to remove the obstacle currently present in the surroundings of the bodywork. The motor current rises characteristically when the obstacle is too heavy and hence the adjustable part no longer can be adjusted any further—by shifting the obstacle.

To alert persons in the surroundings of the vehicle to an upcoming or performed adjustment of the adjustable part for removing an obstacle, a visually and/or acoustically perceptible warning signal can be output at the vehicle before and/or during an adjustment of the adjustable part for removing an obstacle. Such a warning signal output in advance for example enables a person to also remove an object inadvertently placed in an adjustment path of the vehicle door, before it is automatically attempted via the adjustable part to push the object aside. The output of the warning signal can be effected for example on a display of the vehicle in the surroundings of the vehicle door or at the vehicle door.

When an adjustment of the adjustable part is stopped, because the at least one measured value exceeds or falls below a stored threshold value, a feedback signal is additionally generated in one design variant. This feedback signal for example can be wirelessly transmitted to a server device. Then, for example, an operator of the vehicle is informed of the fact that an obstacle has been detected which cannot be removed by means of the adjustable part.

As has already been explained above, the adjustable part in one design variant can comprise a ramp-shaped boarding aid, which below a lower edge of the bodywork opening can be extended and retracted again (into a rest position) in a power-operated way.

In one design variant, the sensor device for the detection of a person in the surroundings of the bodywork opening is activated for a limited period of time. In other words, the sensor device is deactivated before activation, e.g. for saving energy, and is only switched temporarily active in a targeted way in response to an activation event. The sensor device then can be inactive in particular also with the vehicle stopped or stationary, provided that no separate activation has been effected previously. A use of the sensor device for identifying and possibly classifying an object in the surroundings of the vehicle door thus is limited to cases in which the sensor device has previously been activated in a targeted way. Depending on the measurement principle and the performance of the sensor device—this can also be advantageous for data protection reasons, as a use of the sensor device thereby can possibly be limited to cases with an express user approval and can be limited in time.

In this context it is provided for example that the sensor device is activated at a specified stopping point of the vehicle via a mobile terminal of a user. In this connection, a mobile terminal of a user for example can be a smartphone (although alternatively configured mobile terminals are also possible). Via his mobile terminal, a user for example can send an alarm signal to an electronic control unit of the vehicle, which is coupled to the sensor device, in order to switch the sensor device active at a specified stopping point of the vehicle. For example, a user of reduced mobility can inform a vehicle for local public transport of the fact that at a future stopping point—and possibly within a particular time window—a user of reduced mobility probably will enter and for this purpose the sensor device should be activated in order to thereby provide for the automated adjustment of the adjustable part as a boarding aid for this user of reduced mobility. This for example includes the ordering (via the mobile terminal) and hence automated demand-based provision of the sensor-controlled adjustable boarding aid realized with the adjustable part on the vehicle. Consequently, there is provided an at least two-stage method in which a user initially informs an on-board system comprising the at least one sensor device—possibly via a control center or at least one central server—of the fact that the sensor device is activated at a specified stopping point and possibly at a time specified on the part of a user. In a next step, the activated sensor device then allows a sensory identification of a person of reduced mobility and hence the automated adjustment of the adjustable part in order to make it easier for the person of reduced mobility to board the vehicle.

Triggering an alarm signal for activating the otherwise deactivated sensor device can be effected for example by means of a software application (typically short: app) installed on the mobile terminal of the user, in particular before the vehicle reaches the stopping point.

To prevent that the sensor device is repeatedly activated and deactivated again when repeatedly approaching one and the same stopping point in response to an activation signal being triggered once on the part of the user, a time and hence in particular a time window in one design variant can also be predeterminable on the part of a user via the mobile terminal for activation at the specified stopping point of the vehicle. Hence, the targeted activation of the sensor device can also be dependent on a planned and additionally communicated collection time of the user.

Another aspect of the proposed solution relates to an adjustment system for the power-operated adjustment of an adjustable part that is provided at a bodywork opening of a vehicle to be closed by at least one vehicle door. The adjustment system here comprises at least one sensor device via which a person in the surroundings of the bodywork opening (and in one design variant possibly in addition a potential obstacle in an adjustment path of the at least one vehicle door) can be detected. The adjustment system furthermore is configured to carry out a design variant of a proposed method. Correspondingly, a proposed adjustment system for example can comprise an evaluation circuit and an electronic control unit for controlling at least one drive for the adjustable part, which are configured to carry out a design variant of a proposed method.

Furthermore, there is provided a vehicle with at least one proposed adjustment system. For example, such a vehicle can be adapted and provided for autonomous driving. In an autonomously driving vehicle, the proposed solution in one design variant not only offers the advantage that in response to the detection of a person in the surroundings of a bodywork opening an adjustable part is adjusted in addition to a vehicle door. Obstacles rather can also be automatically removed from an adjustment path of a vehicle door by using an adjustable part, which otherwise provides the function of facilitating entry into or exit from the vehicle when the vehicle door is open.

The proposed solution furthermore relates to a computer program product for an electronic control unit of an adjustment system provided for a vehicle. The adjustment system comprises an adjustable part and at least one sensor device, wherein a person in the surroundings of a bodywork opening can be detected via the at least one sensor device. This computer program product contains instructions which on execution of the instructions cause at least one processor of the electronic control unit to carry out a design variant of a proposed method.

### BRIEF DESCRIPTION OF THE DRAWINGS

The attached Figures by way of example illustrate possible design variants of the proposed solution.

FIG. 1A shows a side view of a design variant of a proposed autonomously driving vehicle in the form of a so-called People Mover minibus, comprising a design variant of a proposed adjustment system, when the vehicle doors are closed and obstacles are present in the adjustment path of a vehicle door.

FIG. 1B in a view corresponding with FIG. 1, shows an adjustable part extended on the vehicle of FIG. 1A in the form of a ramp-shaped boarding aid for removing the obstacles when the vehicle doors are still closed.

FIG. 2A in a view corresponding with FIGS. 1A and 1B, shows the opening of the vehicle doors, with a retracted boarding aid for a person detected in front of the vehicle doors.

FIG. 2B in a view corresponding with FIG. 2A and with the scenario underlying FIG. 2A, shows the boarding aid in the extended state, in order to make it easier for the person to board the vehicle.

### DETAILED DESCRIPTION

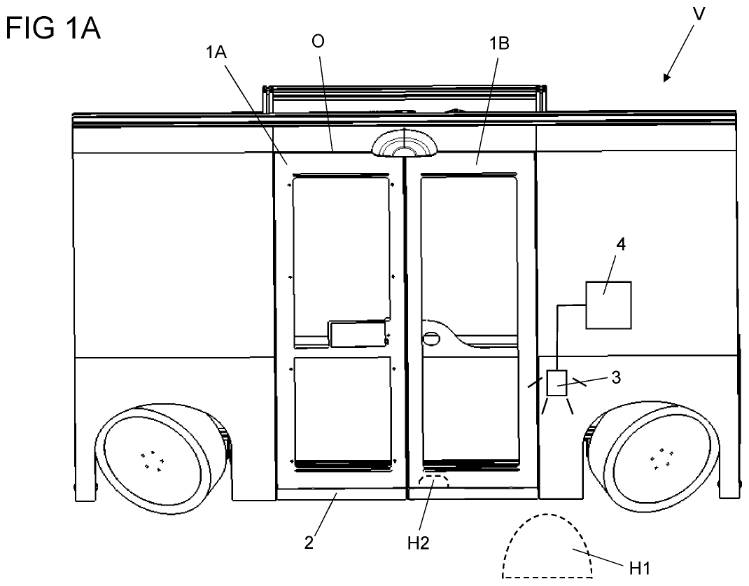

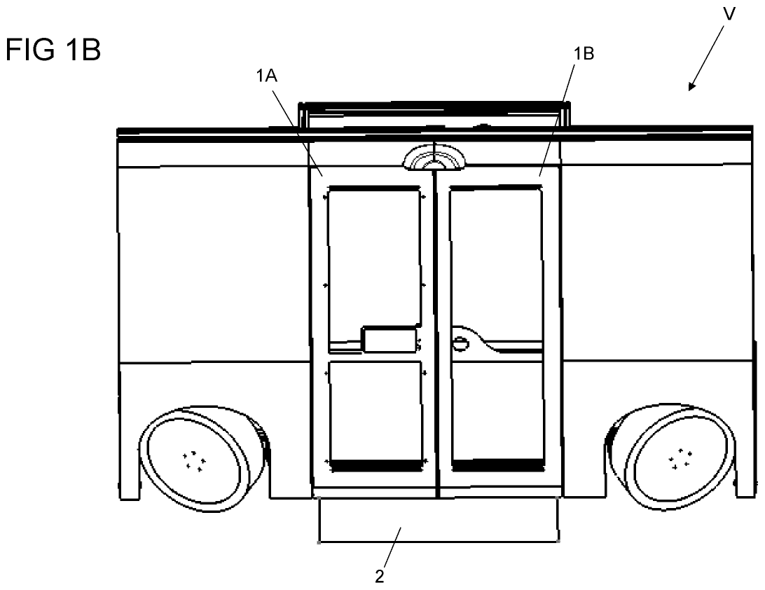

FIG. 1A shows a vehicle V in the form of an autonomously driving People Mover minibus. The vehicle V laterally has a bodywork opening O that can be closed by two pivotable vehicle doors 1A and 1B, which are each adjustable via a motor.

Below a lower edge of the bodywork opening O and hence below the closed vehicle doors 1A and 1B, an actuating unit in the form of a ramp-shaped boarding aid 2 is accommodated at the vehicle V. The boarding aid 2 can be extended and retracted in a power-operated way via at least one motorized drive, for example an electromotive drive, in order to in particular make it easier for a person of reduced mobility to board or alight from the vehicle V when the vehicle doors 1A and 1B are open.

The vehicle V includes an electronic control unit 4 for controlling the motorized drives of the vehicle doors 1A and 1B and of the boarding aid 2. This electronic control unit 4 is coupled to at least one sensor device 3 of the vehicle V, via which an object in the surroundings of the bodywork opening O can be detected. The sensor device 3 for example comprises a camera and/or a lidar sensor and is adapted to detect objects in the surroundings of the bodywork opening O and to classify the same as a person or potential obstacle in the adjustment path of a vehicle door 1A, 1B to be opened or closed. For example, when after the standstill of the vehicle V with the vehicle doors 1A, 1B still closed, an obstacle H1 is detected on a vehicle underside or an obstacle H2 is placed and detected directly in front of one of the vehicle doors 1A or 1B, opening of the vehicle doors 1A and 1B initially will be omitted. Rather, an adjustment scenario corresponding to FIG. 1B is triggered, in which it is attempted by means of the extending boarding aid 2, with the vehicle doors 1A and 1B still closed, to remove the respective obstacle H1 or H2 from the adjustment path of the vehicle doors 1A and 1B by shifting.

The classification of an identified object in the surroundings of the bodywork opening O can be effected by using at least two predefined object classes. Then, for example, the detection of a person for which an adjustment of the adjustable part 2 is to be triggered is signaled via an assignment of an identified object to a first object class, while the detection of an obstacle that limits an adjustment of at least one of the vehicle doors 1A, 1B is signaled via an assignment of the object to a second object class. Thus, depending on the classification of the object one of at least two different types of object is assumed, which in response thereto lead to different measures with respect to the adjustment of the adjustable part 2 and possibly also of the vehicle doors 1A and 1B.

Before and during an adjustment of the boarding aid 2, a warning signal is output in order to visually and/or acoustically inform persons standing in the surroundings of the vehicle V that the boarding aid 2 is extended or retracted at the bodywork opening O. During the adjusting operation of the boarding aid 2, for example, a motor current of a drive motor provided for the adjustment of the boarding aid 2 is monitored and/or measured values representative of the adjusting operation, e.g. of a Hall sensor, are evaluated. If the detected object or one of the obstacles H1 or H2 is too heavy and the motor current hence will rise above a threshold value regarded as critical, the adjusting operation is stopped. Such stopping of the adjusting operation additionally can trigger the generation and sending of a feedback signal to an operator of the vehicle V, in order to inform the same of the failed removal of an obstacle.

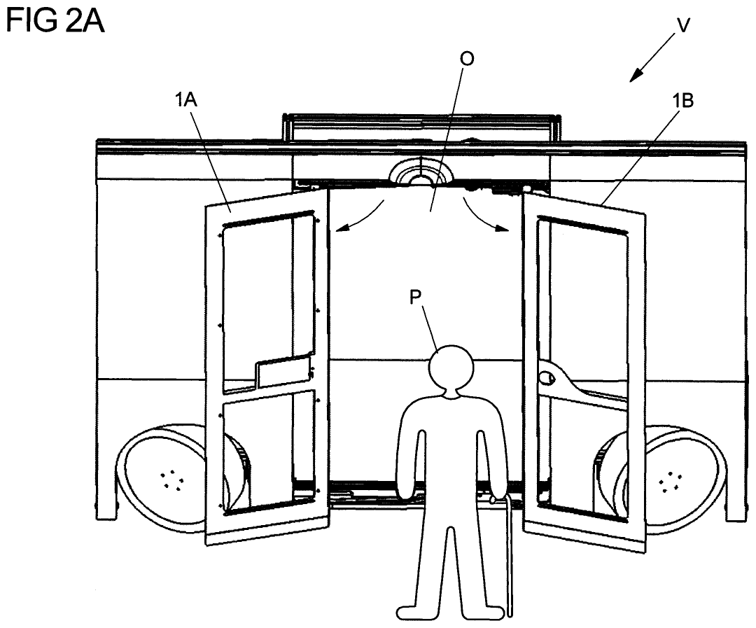

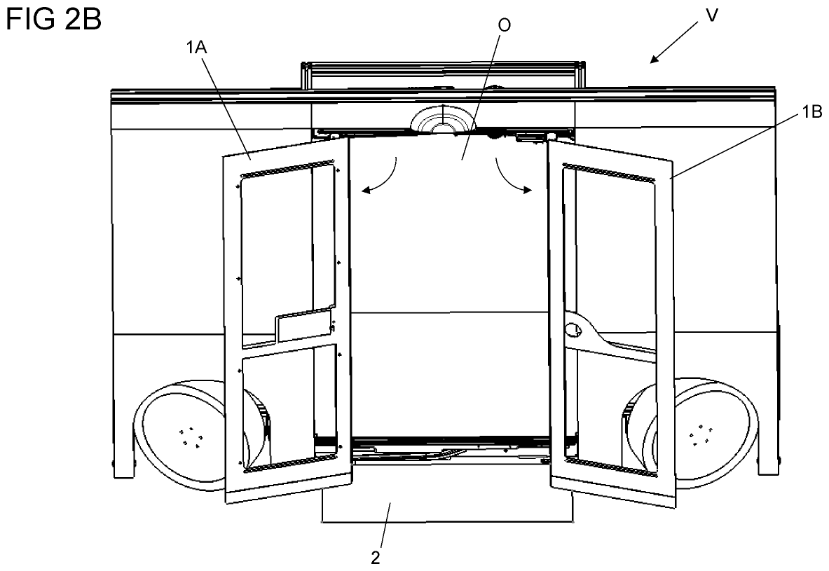

When after the removal of the obstacles H1 and H2 or already when no obstacle previously is present in the surroundings of the bodywork opening O, a person P is detected (in a contactless way by means of the sensor device 3) in front of the vehicle doors 1A and 1B, a different adjustment scenario is electronically triggered. Corresponding to FIG. 2A, the two vehicle doors 1A and 1B initially are opened in a power-operated way to clear the bodywork opening O. Subsequently, the boarding aid 2 is extended below the vehicle doors 1A and 1B, if necessary. This includes both the possibility that the boarding aid 2 first is extended, before the vehicle doors 1A and 1B are opened, and that the boarding aid 2 is extended with or after opening of the vehicle doors 1A and 1B.

A power-operated adjustment of the boarding aid 2 carried out merely if necessary and coordinated with the adjusting movement of the vehicle doors 1A and 1B is effected for example in dependence on the presence of an additional adjustment criterion with reference to measurement data detected by means of the sensor device 3. When the detected measurement data for example allow to infer a person P of reduced mobility, for example due to the presence of a wheelchair, a crutch and/or a walking stick, an additional adjustment of the boarding aid 2 is triggered. Alternatively, independently of the presence of an additional criterion on detection of a person P in front of the bodywork opening (inside or outside the vehicle V) the boarding aid 2 is extended in order to make exit easier for a person present in the vehicle V or to make entry into the vehicle V easier for a person P present outside the vehicle V.

In principle, the boarding aid 2 can also remain in an extended position into which the boarding aid 2 has been adjusted previously, in order to remove an obstacle H1 or H2. This boarding aid 2 consequently need not be retracted again after removal of an obstacle, in particular need not be retracted completely, when entry or exit is to be made easier via the boarding aid 2 subsequent to the removal of an obstacle. This in particular includes the possibility that the boarding aid 2 is not retracted again after completion of the removal of an obstacle, but at least is moved into another adjustment position.

An adjustment of the boarding aid 2 for removing at least one obstacle can also be provided when the vehicle doors 1A and 1B are open and a potential obstacle is present in the adjustment path of a vehicle door 1A or 1B to be closed.

To avoid any damage to the boarding aid 2, the boarding aid 2 for example can have a rubber cover on a front edge. Furthermore, depending on the type of the vehicle V and its equipment variant, different performance classes can be provided for the boarding aid 2 and its drive. Depending on the provided motorized drive, obstacles of different weight can thus be removed from an adjustment area of the vehicle doors 1A and 1B.

Via the electronic control unit 4 and the at least one sensor device 3, an object in the surroundings of the vehicle doors 1A, 1B in FIGS. 1A to 2B in principle can, however, not only be assigned to two different object classes, which on the one hand are representative of an (individual) person P (possibly of reduced mobility) or an obstacle H1, H2. In accordance with the proposed solution it rather is also possible for other object distinctions to be made as well via two or more object classes. It can be provided for example that by means of the electronic control unit 4 and the sensor device 3 a detected object can be classified as a group of persons and/or as a mobile transportation unit (and hence for example as a cargo transportation robot).

Depending on the object class to which a detected object is assigned, a different adjustment scenario can be triggered via the electronic control unit 4 for the adjustment of the boarding aid 2. These adjustment scenarios, as already explained above, can differ from each other for example as regards the course of an adjustment speed of the boarding aid 2, the course of an acceleration of the boarding aid 2 (on retraction and/or on extension) and/or a course of the (extended) boarding aid 2, in particular its extended length or its inclination with respect to the lower edge of the bodywork opening O.

In this way, for example, a slower adjustment speed can each be provided for the extending boarding aid 22 at locations with a large number of people or at locations where many people are to board the vehicle V. This reduces the risk of injury from the extending boarding aid 2, as it makes it easier for persons to get out of the way in front of the body opening O, even with a large number of persons.

Alternatively or additionally, an adjustment scenario can vary for an extending boarding aid 2 in dependence on whether at least one person (i.e. in particular an individual person or also several persons/a group of persons) is detected in front of the bodywork opening O or exclusively a mobile transportation unit is detected in front of the bodywork opening O. When there is at least one person, a lower adjustment speed and a smaller inclination angle of the boarding aid 2 can be assumed as compared to a mobile transportation unit. Higher adjustment speeds and/or a steeper inclination angle of the extended boarding aid 2 possibly can provide for faster boarding times and hence faster loading times for the mobile transportation unit, while boarding is more comfortable for a person with a lower adjustment speed and/or a small inclination angle.

The electronic control unit 4 of the vehicle V furthermore can be coupled to at least one mobile terminal of a user—via a network, in particular the Internet and hence in particular wirelessly-, in order to receive an activation signal from the mobile terminal, via which the sensor device 3 is activated only when necessary. For example, the sensor device 3 can be deactivated to save energy and/or for reasons of data protection and hence cannot be switched permanently active. Only in response to a user request, which for example is transmitted to the electronic control unit 4 via an app on the mobile terminal of the user, is the sensor device 3 activated in order to identify and classify an object in the surroundings of the bodywork opening O at a particular stopping point of the vehicle V. In this way, for example, a person of reduced mobility, such as a wheelchair user, can use a mobile terminal to specifically trigger the activation of the sensor device 3 at a stopping point at which the person of reduced mobility wants to board the vehicle V. Via the sensor device 3 then specifically activated at this stopping point, the person of reduced mobility can then be identified, and the adjustment of the boarding aid 2 can be triggered automatically.

To have the boarding aid 2 extend and/or retract also independently of a sensorially supported classification of an object in the surroundings of the bodywork opening O, at least one separate actuating element, such as e.g. a tip switch, can be provided at the vehicle V, via which a drive can be actuated for the power-operated adjustment of the boarding aid 2.

### LIST OF REFERENCE NUMERALS

1A, 1B vehicle door
2 boarding aid (adjustable part)
3 sensor device
4 electronic control unit
H1, H2 obstacle
O bodywork opening
P person
V vehicle

1. A method for adjusting an adjustable part that is provided at a bodywork opening of a vehicle to be closed by at least one vehicle door, wherein
a power-operated adjustment of the adjustable part is controlled by using at least one sensor device, via which a person in the surroundings of the bodywork opening can be detected and via which the power-operated adjustment of the adjustable part can be triggered in order to make it easier for the person to board or alight from the vehicle when the vehicle door is open.

2. The method according to claim 1, wherein an object in the surroundings of the bodywork opening can be detected by using the at least one sensor device, and the detected object is assigned to one of at least two predefined object classes, and in dependence on the object class to which the detected object is assigned, one of at least two different adjustment scenarios is triggered for the power-operated adjustment of the adjustable part.

3. The method according to claim 2, wherein by means of the at least two object classes, a detected object can be classified as at least one of
a person,
an obstacle
a group of persons and
a mobile transportation unit.

4. The method according to claim 1, wherein an object in the surroundings of the bodywork opening can be detected by using the at least one sensor device, and the detected object is assigned to one of at least two predefined object classes, wherein on assignment of the object to a first object class of the at least two predefined object classes the detection of a person is assumed, for which an adjustment of the adjustable part is to be triggered, and on assignment of the object to a second object class of the at least two predefined object classes the detection of an obstacle is assumed, which limits an adjustment of the at least one vehicle door.

5. The method according to claim 4, wherein, when an obstacle limiting an adjustment of the at least one vehicle door is detected in the surroundings of the bodywork opening via the at least one sensor device, the adjustable part is adjusted in a power-operated way for removing the obstacle.

6. The method according to claim 4, wherein via the at least one sensor device a person can be distinguished from an obstacle limiting an adjustment of the at least one vehicle door and in dependence on whether a person is detected in the surroundings of the bodywork opening or an obstacle limiting the adjustment of the at least one vehicle door, one of at least two different adjustment scenarios is triggered for the power-operated adjustment of the adjustable part.

7. The method according to claim 6, wherein, when a person, is detected in the surroundings of the bodywork opening, a first adjustment scenario is triggered, in which the at least one vehicle door and the adjustable part are adjusted in a power-operated way at the same time or one after the other in a coordinated way, and when an obstacle is detected in the surroundings of the bodywork opening a second adjustment scenario is triggered, in which merely the adjustable part is adjusted in a power-operated way.

8. The method according to claim 4, wherein via the at least one sensor device a person and an obstacle can be distinguished from each other with reference to at least one of a size, a weight and a contour.

9. The method according to claim 3, wherein an object in the surroundings of the bodywork opening can be detected by using the at least one sensor device, and the detected object is assigned to one of at least two predefined object classes, wherein on assignment of the object to a first object class of the at least two predefined object classes the detection of a person is assumed, for which an adjustment of the adjustable part is to be triggered, and on assignment of the object to a second object class of the at least two predefined object classes the detection of an obstacle is assumed, which limits an adjustment of the at least one vehicle door, wherein a power-operated adjustment of the adjustable part on detection of a person in the surroundings of the bodywork opening differs from a power-operated adjustment of the adjustable part when an obstacle is to be removed by the adjustable part.

10. (canceled)

11. The method according to claim 3, wherein an object in the surroundings of the bodywork opening can be detected by using the at least one sensor device, and the detected object is assigned to one of at least two predefined object classes, wherein on assignment of the object to a first object class of the at least two predefined object classes the detection of a person is assumed, for which an adjustment of the adjustable part is to be triggered, and on assignment of the object to a second object class of the at least two predefined object classes the detection of an obstacle is assumed, which limits an adjustment of the at least one vehicle door, wherein, when an obstacle limiting an adjustment of the at least one vehicle door is detected in the surroundings of the bodywork opening via the at least one sensor device, the adjustable part is adjusted in a power-operated way for removing the obstacle, and an adjustment of the adjustable part for removing an obstacle during standstill of the vehicle is dependent on whether the obstacle was present already before standstill of the vehicle and/or for what period the obstacle is detected via the at least one sensor device.

12. The method according to claim 5, wherein an adjustment of the adjustable part for removing an obstacle is electronically monitored with reference to at least one measured value, and the adjustment is stopped when the at least one measured value exceeds a stored threshold value or when the at least one measured value falls below a stored threshold value.

13. (canceled)

14. The method according to claim 3, wherein an object in the surroundings of the bodywork opening can be detected by using the at least one sensor device, and the detected object is assigned to one of at least two predefined object classes, wherein on assignment of the object to a first object class of the at least two predefined object classes the detection of a person is assumed, for which an adjustment of the adjustable part is to be triggered, and on assignment of the object to a second object class of the at least two predefined object classes the detection of an obstacle is assumed, which limits an adjustment of the at least one vehicle door, wherein, when an obstacle limiting an adjustment of the at least one vehicle door is detected in the surroundings of the bodywork opening via the at least one sensor device, the adjustable part is adjusted in a power-operated way for removing the obstacle, and before and/or during an adjustment of the adjustable part for removing an obstacle, a visually and/or acoustically perceptible warning signal is output at the vehicle.

15. The method according to claim 1, wherein the adjustable part comprises a ramp-shaped boarding aid which can be extended and retracted again in a power-operated way below a lower edge of the bodywork opening.

16. The method according to claim 1, wherein the at least one sensor device comprises at least one of a camera and and/or a lidar sensor.

17. The method according to claim 1, wherein the sensor device is activated for a limited period to detect a person in the surroundings of the bodywork opening.

18. The method according to claim 17, wherein the sensor device is activated at a specified stopping point of the vehicle via a mobile terminal of a user.

19. (canceled)

20. (canceled)

21. An adjustment system for the power-operated adjustment of an adjustable part that is provided at a bodywork opening of a vehicle to be closed by at least one vehicle door, wherein the adjustment system comprises at least one sensor device via which a person can be detected in the surroundings of the bodywork opening, and wherein the adjustment system is configured to carry out a method according to claim 1.

22. A vehicle comprising at least one adjustment system according to claim 21.

23. The vehicle according to claim 22, wherein the vehicle is adapted and provided for autonomous driving.

24. A computer program product for an electronic control unit of an adjustment system provided for a vehicle, wherein the adjustment system comprises an adjustable part and at least one sensor device, and via the at least one sensor device a person in the surroundings of a bodywork opening can be detected, and wherein the computer program product includes instructions that cause at least one processor of the electronic control unit to carry out a method according to claim 1 on execution of the instructions.
